(19) United States
(12) Patent Application Publication
(10) Pub. No.: US 2008/0224880 A1
(43) Pub. Date: Sep. 18, 2008

(54) TOILET SEAT SENSOR DEVICE

(76) Inventor: David Valentine, La Jolla, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/685,541

(22) Filed: Mar. 13, 2007

(51) Int. Cl. G08B 21/22

(52) U.S. Cl. 340/686.6

(57) ABSTRACT

A sensor device (6) for a toilet having a seat moveable between a raised position and lowered position is provided. The sensor device (6) includes a housing (8) adapted to be removably coupled to the toilet and a controller (18) disposed within the housing (8). The sensor device (6) further includes a motion sensor (16) in communication with the controller (18) and adapted to activate a first signal when the seat is in either the raised or lowered position and a user is positioned within a first predetermined range of the toilet.

### BACKGROUND

A conventional toilet typically includes a toilet bowl and a toilet seat that is movable between a lowered position and a raised position. For a variety of reasons, it is desirable that the toilet seat is left in the lowered positioned for the next user.

Currently, there are devices available to provide some indication to a user that the toilet seat is in the raised position. Several devices sense the position of the toilet seat and continuously alert the user audibly or visually that the seat is in the raised position. These devices continuously sound an alarm when the seat is raised or when the seat has been left in the raised position.

Sounding an alarm when the toilet seat is in the raised position after use is effective, but has its drawbacks. As an example, none of the prior art devices protect the next user when the previous user ignores the alarm. Thus, there is a need for an improved toilet sensor that warns the next user when the seat has inadvertently been left in the raised position.

### SUMMARY

A sensor device for a toilet having a seat moveable between a raised position and lowered position is provided. The sensor device includes a housing adapted to be removably coupled to the toilet and a controller disposed within the housing. The sensor device further includes a motion sensor in communication with the controller and adapted to activate a first signal when the seat is in either the raised or lowered position and a user is positioned within a first predetermined range of the toilet.

This summary is provided to introduce several concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become readily appreciated by reference to the following detailed description, when taken in conjunction with the accompanying drawings, wherein:

FIG. 1 is an environmental view of one embodiment of a toilet seat sensor device shown in use on a toilet;

FIG. 2 is a block diagram of internal components of the toilet seat sensor device of FIG. 1; and

FIG. 3 is a block diagram showing a control schematic for the toilet seat sensor device of FIG. 1.

### DETAILED DESCRIPTION

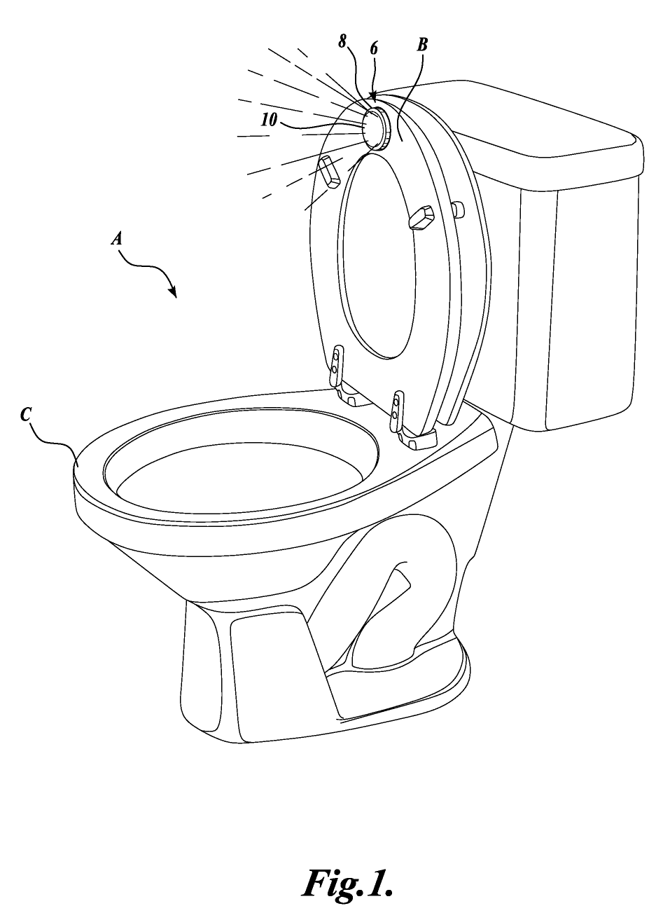

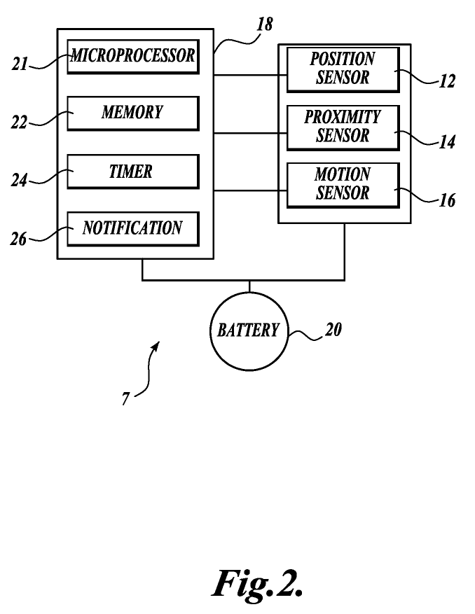

A toilet seat sensor device 6 constructed in accordance with one embodiment of the present disclosure is best seen by referring to FIG. 1. The sensor device 6 is suitable for use with a toilet A having a toilet seat B and a toilet bowl C. The sensor device 6 includes an array of internal sensor components 7 (shown in FIG. 2) that are contained within a housing 8. The toilet sensor device 6 further includes a cover 10 adapted to be secured to the housing 8 in any suitable manner to enclose the array of internal sensor components 7 therein.

The housing 8 is mountable to the underside of the toilet seat B in any well-known manner, such as with an adhesive. The sensor device 6 is mounted at about the waist level to the underside of the forward end of the toilet seat B to sense a person standing in front of the toilet A when the seat B is raised. In this position, the sensor device 6 will be the farthest away from the toilet seat C when the seat B is in the raised position, keeping the sensor device 6 away from any possible urination splatter. It should be appreciated, however, that the sensor device 6 may be mounted anywhere on the toilet seat B without detracting from its function and purpose.

The housing 8 and cover 10 is made from any suitable water-resistant material, such as plastic. The sensor device 6 may be any preferred shape, such as round, square, etc. Moreover, the sensor device 6 is suitably sized to fit on the underside of the toilet seat B without protruding from the perimeter of the toilet seat B when the toilet seat B is in the lowered position or interfering with the closure or lowering of the toilet seat B.

Referring to FIG. 2, the sensor components 7 will now be described in greater detail. The sensor components 7 include a position sensor 12, a proximity sensor 14, and a motion sensor 16, a controller 18, and a battery 20. One or more of the internal sensor components 7 can be manufactured as a single silicon chip; however, each component will be discussed separately for clarity and ease of illustration.

The position sensor 12 detects the orientation and position of the toilet seat B. The position sensor 12 may be any suitable mechanical, optical, or electrical sensor, such as a tilt sensor, a programmable tilt switch, etc. The position sensor 12 sends a signal to the controller 18 when the toilet seat B is moved from the lowered position to the raised position or when it is moved from the raised position to the lowered position.

The proximity sensor 14 may be any suitable optical or electrical sensor, such as a capacitive sensor, a photoelectric sensor, or an infrared sensor that is capable of sensing an object, such as a person, within the proximity sensor range. The proximity sensor range may be any suitable range, such as a 180 degree 3 foot range from the sensor 14 when the toilet seat B is in the raised position. When the user moves beyond the predetermined proximity sensor range, the proximity sensor 14 sends a signal to the controller 18, and the controller 18 initiates a warning. The warning will sound, flash, etc., until the position sensor 12 sends a signal to the controller 18 indicating that that seat B has been lowered. If the seat B is not lowered, the warning will sound, flash, etc., until a predetermined amount of time, such as 10 seconds, elapses. If the seat B is left in the raised position and the predetermined amount of time elapses, the motion sensor 16 will override the proximity sensor 14 to detect a person walking towards the toilet A with the seat B in the raised position. The motion sensor 16 may be any suitable off-the-shelf motion sensor, such as an infrared motion detector. The motion sensor 16 is activated when a person moves into a predetermined motion detector range surrounding the toilet A when the toilet seat B has been left in the raised position. The predetermined motion detector range could be, for instance, a 180 degree 10 foot range from the motion detector 16. When the user moves into the predetermined motion detector range, the motion sensor 16 sends a signal to the controller 18 to produce a warning. The warning alerts the user that the toilet seat B is in the raised position. The warning is disabled when position sensor 12 sends a signal to the controller 18 indicating that the seat B has been lowered, when the user leaves the predetermined motion detector range, or when a predetermined amount of time elapses.

The controller 18 may be any suitable logic controller that includes a microprocessor 21 for processing the sensor inputs. The controller 18 also includes a memory unit 22, a timer 24, and a notification device 26, all in communication with the microprocessor 21.

The memory unit 22 may be any suitable device that stores instructions and logic for processing the sensor input signals. The timer 24 is any suitable device that interfaces with the microprocessor 21 to disable the notification device 26 after a certain period of time. For example, when a user raises the toilet seat B and thereafter leaves the predetermined area, the notification will be produced for a limited amount of time, such as ten seconds.

The notification device 26 may be any suitable device for producing audible or visual warnings, such as alarms, songs, chimes, flashing lights, colored lights, or other notifications. The microprocessor 21 may, if desired, instruct the notification device 26 to produce a different notification in response to different signal inputs. For instance, a standard alarm may sound when the seat B is left in the raised position, yet a soft chime, a flashing light, or another non-startling warning may be generated when a user approaches the seat B in the raised position. In this manner, a user who approaches the toilet in the middle of the night, for instance, is not startled by the loud noise.

Still referring to FIG. 2, the internal battery 20 is in electrical communication with the array of internal sensor components 7. The battery 20 may be any well-known battery that has sufficient power to support a sufficiently large number of toilet seat “cycles” (one cycle being the raising and lowering of the toilet seat B) or any other suitable lifespan of the sensor device 6.

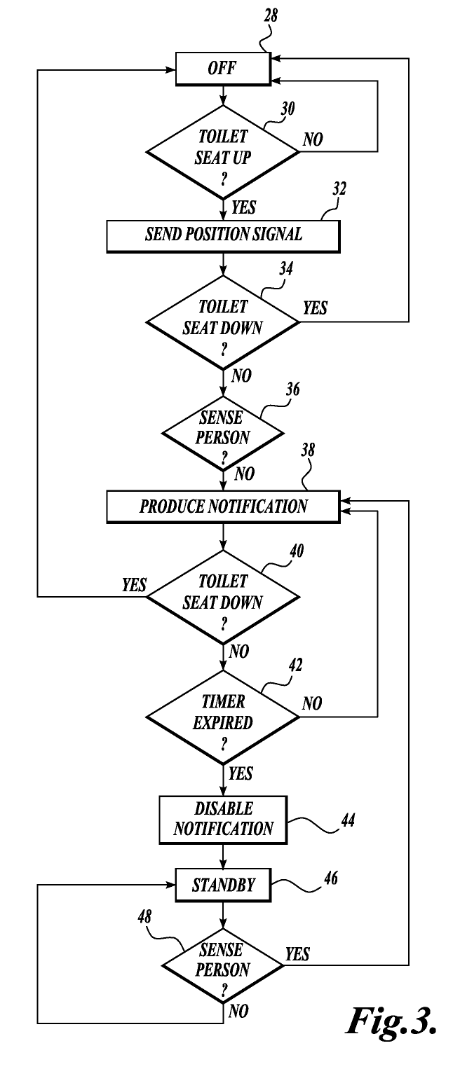

Operation of the sensor device 6 may be best understood by referring to FIG. 3. When the toilet seat B is in the lowered position, the sensor device 6 is OFF, as indicated by block 28. A user activates the sensor device 6 by raising the toilet seat B, as indicated by decision block 30. When the seat B is raised, the position sensor 12 sends a signal to the controller 18 indicating that the seat B is in the raised position, as indicated by block 32.

If the user lowers the seat B after using the toilet A (as indicated by decision block 34), the sensor device 6 turns OFF, as indicated by block 28. However, if the user leaves the toilet seat B in the raised position and then leaves the predetermined proximity sensor range, the proximity sensor 14 sends a signal to the controller 18, as indicated by block 36. The controller 18 processes the signal and sends power to the notification device 26 to produce a notification, such as an alarm, as indicated by block 38. The controller 18 also starts the timer 24, as indicated by block 42.

If, after hearing or seeing the alarm, the user returns to the toilet A and lowers the seat B, the position sensor 12 sends a signal to the controller 18 indicating that the toilet seat is in the lowered position, as indicated by decision block 40. At this point, the sensor device 6 turns OFF, as indicated by block 28. If, however, the user does not return to the toilet A to lower the seat B, the alarm will continue to sound until the timer 24 elapses (as indicated by decision block 42) and signals the controller 18 to disable the notification device 26, as indicated by block 44. The timer 24 could be set to elapse, for example, after 10 seconds.

After the timer 24 elapses and the alarm is disabled, the sensor device 6 goes a standby mode, as indicated by block 46. The sensor device 6 remains in this standby mode until a user enters the predetermined motion detector range and the motion sensor 16 sends a signal to the controller 18, as indicated by decision block 48. The controller 18 processes the signal and sends power to the notification device 26 to produce a notification, such as an alarm, as indicated by block 38.

The alarm will continue to sound until either the seat B is lowered or the timer 24 elapses, as indicated by decision blocks 40 and 42. Preferably, the alarm sounds for a sufficient amount of time such that the user is warned that the toilet seat B is in the raised position. However, the alarm is also sufficiently brief in duration such that if the user wishes to use the toilet A with the seat B in the raised position, the alarm is not going off for the entire duration of use.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A sensor device for a toilet having a seat moveable between a raised position and lowered position, the sensor device comprising:
(a) a housing adapted to be removably coupled to the toilet;
(b) a controller disposed within the housing; and
(c) a motion sensor in communication with the controller and adapted to activate a first signal when the seat is in one of the raised position and the lowered position and a user is positioned within a first predetermined range of the toilet.

2. The sensor device of claim 1, further comprising a proximity sensor in communication with the controller and adapted to activate a second signal when the seat is in the raised or lowered position and a user moves out of a second predetermined range of the toilet.

3. The sensor device of claim 1, wherein the controller comprises a notification device for producing a first notification in response to the first signal when the seat is in the raised position.

4. The sensor device of claim 3, wherein the notification device further produces a second notification in response to the second signal when the seat is in the raised position.

5. The sensor device of claim 3, wherein the first notification is stopped when the seat is moved into the lowered position.

6. The sensor device of claim 3, wherein the first notification is stopped when the user moves out of the first predetermined range.

7. The sensor device of claim 3, wherein the first notification is stopped after a predetermined amount of time.

8. The sensor device of claim 4, wherein the second notification is stopped when either the seat is moved into the lowered position or after a predetermined period of time.

9. The sensor device of claim 1, further comprising a position sensor in communication with the controller and adapted to activate a third signal when the seat is moved into one of the raised position and the lowered position.

10. A sensor device for a toilet having a seat moveable between a raised position and lowered position, the sensor device comprising:
(a) a housing adapted to be removably coupled to the toilet;
(b) a controller disposed within the housing;
(c) a motion sensor in communication with the controller and adapted to activate a first signal when the seat is in one of the raised position and the lowered position and a user is positioned within a first predetermined range of the toilet;
(d) a proximity sensor in communication with the controller and adapted to activate a second signal when the seat is in the raised or lowered position and a user moves out of a second predetermined range of the toilet; and
(e) a notification device in communication with the controller for producing a first notification in response to the first signal when the seat is in the raised position and a second notification in response to the second signal when the seat is in the raised position.

11. The sensor device of claim 10, further comprising a position sensor in communication with the controller and adapted to activate a third signal when the seat is moved into either the raised or lowered position.

12. The sensor device of claim 10, wherein the first notification is stopped when the seat is moved into the lowered position, after a predetermined amount of time, or when the user moves out of the first predetermined range.

13. The sensor device of claim 10, wherein the second notification is stopped when either the seat is moved into the lowered position or after a predetermined amount of time.

14. A method of providing warnings to users of a toilet, wherein the toilet includes a seat that is moveable between a raised position and lowered position, the method comprising:
(a) activating a first signal when the seat is in the raised or lowered position and a user moves into a first predetermined range of the toilet;
(b) producing a first notification in response to the first signal;
(c) activating a second signal when the seat is in the raised or lowered position and a user moves out of a second predetermined range of the toilet; and
(d) producing a second notification in response to the second signal.

15. The method of claim 14, further comprising activating a third signal when the seat is moved into the raised or lowered position.

16. The method of claim 14, further comprising stopping the first notification when the seat is moved into the lowered position

17. The method of claim 14, further comprising stopping the first notification after a predetermined amount of time.

18. The method of claim 14, further comprising stopping the first notification when the user moves out of the first predetermined range.

19. The method of claim 14, further comprising stopping the second notification when either the seat is moved into the lowered position or after a predetermined amount of time.
